(19) United States
(12) Patent Application Publication
(10) Pub. No.: US 2025/0315027 A1
(43) Pub. Date: Oct. 9, 2025

(54) VIRTUAL SEMICONDUCTOR FAB ENVIRONMENT

(71) Applicant: Lam Research Corporation, Fremont, CA (US)

(72) Inventors: Kapil SAWLANI, Ann Arbor, MI (US); Paul FRANZEN, West Linn, OR (US); Brian Joseph WILLIAMS, Tigard, OR (US)

(21) Appl. No.: 18/860,936

(22) PCT Filed: May 11, 2023
(86) PCT No.: PCT/US2023/066883

§ 371 Date: Oct. 28, 2024

Related U.S. Application Data
(60) Provisional application No. 63/364,667, filed on May 13, 2022.

(51) Int. Cl. G05B 19/4099

(52) U.S. Cl. CPC G05B 19/4099; G05B 2219/45031

(57) ABSTRACT

Examples are disclosed that relate to virtual semiconductor fab environments. One example provides a method of monitoring a process performed on a substrate in a processing tool. The method comprises obtaining runtime data from sensors of the processing tool while running the process in the processing tool. The method further comprises performing a runtime simulation by simulating a digital twin using the runtime data and a recipe for the process. The method further comprises receiving a selection of a spatial viewpoint within the digital twin of the processing tool. The method further comprises rendering an image of a virtual state of the processing tool using the runtime simulation and the spatial viewpoint, and outputting the image of the virtual state.

### BACKGROUND

Semiconductor device fabrication processes can involve many steps of material deposition, patterning, and removal to form integrated circuits on substrates. As such, a semiconductor device fabrication plant (a “fab” or “foundry”) can have a large number of different processing tools for performing hundreds or even thousands of individual steps to form semiconductor devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to virtual semiconductor fab environments. One example provides a method of virtually monitoring a process performed on a substrate in a processing tool. The method comprises obtaining runtime data from sensors of the processing tool while running the process in the processing tool. The method further comprises performing a runtime simulation by simulating a digital twin of a processing tool using the runtime data and a recipe for the process. The method further comprises receiving a selection of a spatial viewpoint within the digital twin of the processing tool. The method further comprises rendering an image of a virtual state of the processing tool using the runtime simulation and the spatial viewpoint, and outputting the image of the virtual state.

In some such examples, receiving the selection of the spatial viewpoint within the digital twin alternatively or additionally comprises receiving a selection of two or more spatial viewpoints. In such examples, rendering the image of the virtual state of the processing tool alternatively or additionally comprises rendering a first image of the virtual state at a first spatial viewpoint and rendering a second image of the virtual state at a second spatial viewpoint.

In some such examples, rendering the image of the virtual state of the processing tool alternatively or additionally comprises changing one or more of a location, a direction, or a field of view of a rendering camera within the digital twin.

In some such examples, rendering the image of the virtual state of the processing tool alternatively or additionally comprises rendering a video depicting evolution of the virtual state of the processing tool over time.

In some such examples, the image alternatively or additionally comprises one or more of a simulated thermal image, a simulated visible image, a simulated density image, or a simulated field.

In some such examples, the method alternatively or additionally comprises obtaining a substrate map of metrology data for the substrate processed in the processing tool using the process. In such examples, rendering the image of the virtual state of the processing tool alternatively or additionally comprises overlaying a representation of the substrate map of the metrology data on a virtual substrate of the runtime simulation.

In some such examples, the runtime simulation alternatively or additionally is a first runtime simulation for a process comprising one or more anomalies, the virtual state alternatively or additionally is a first virtual state, the runtime data alternatively or additionally is first runtime data. In such examples, the method alternatively or additionally comprises obtaining a second virtual state of the processing tool from a second runtime simulation of the digital twin simulated with second runtime data from a process without anomalies, comparing at least a portion of the first virtual state to a corresponding portion of the second virtual state, and outputting one or more differences based upon the comparison.

Another example provides a computing device comprising a display subsystem, a logic subsystem, and a storage subsystem comprising instructions executable by the logic subsystem. The instructions are executable to receive a user input selecting a spatial viewpoint within a digital twin of a processing tool, receive a user input selecting a set of runtime data acquired by the processing tool, and provide the user input selecting the spatial viewpoint and the user input selecting the set of runtime data to a simulation service of a virtual semiconductor fab environment. The instructions are further executable to receive, from the simulation service, data from a runtime simulation that represents a virtual state of the processing tool using the digital twin, and display a rendered image of the virtual state from the spatial viewpoint selected.

In some such examples, the instructions to receive the user input selecting the set of runtime data acquired by the processing tool alternatively or additionally comprise instructions executable to receive user inputs of a plurality of different spatial viewpoints, and the instructions executable to display the rendered image of the virtual state from the spatial viewpoint alternatively or additionally comprise instructions executable to display rendered images from the plurality of different spatial viewpoints.

In some such examples, the instructions are alternatively or additionally executable to receive an input changing one or more of a location, a direction, or a field of view of a rendering camera within the digital twin, and to display an updated rendered image of the virtual state after changing the one or more of the location, the direction, or the field of view.

In some such examples, the computing device alternatively or additionally comprises a head-mounted display device.

In some such examples, the instructions executable to receive the user input selecting the spatial viewpoint alternatively or additionally comprise instructions executable to receive user input by one or more of a head-tracking camera or an eye-tracking camera.

In some such examples, the virtual state alternatively or additionally comprises a substrate map, and the instructions executable to display a rendered image of the virtual state comprise instructions executable to display the substrate map over a virtual substrate.

In some such examples, the instructions are alternatively or additionally executable to receive a notification of an anomaly in the set of runtime data, and in response, display the notification.

Another example provides a computing system comprising a logic subsystem comprising one or more processors, and a storage subsystem comprising instructions executable to operate a digital twin of a processing tool. The storage subsystem also comprises instructions executable by the one or more processors to obtain runtime data from the processing tool. The runtime data comprises data acquired by sensors of the processing tool while running a process in the processing tool. The instructions are further executable to detect an anomalous condition in the runtime data, in response to detecting the anomalous condition, perform a runtime simulation by simulating the digital twin using one or more of the runtime data or a recipe for the process, and determine a probable cause of the anomalous condition using data from the runtime simulation.

In some such examples, the instructions alternatively or additionally are executable to determine a recommended diagnostic procedure.

In some such examples, the instructions alternatively or additionally are executable to output one or more of an alert indicating the anomalous condition or the recommended diagnostic procedure.

In some such examples, the instructions alternatively or additionally are executable to render an image of a virtual state of the processing tool using the runtime simulation.

In some such examples, the image alternatively or additionally comprises one or more of a simulated thermal image, a simulated visible image, a simulated density image, or a simulated field.

In some such examples, the runtime simulation alternatively or additionally is a first runtime simulation, the runtime data alternatively or additionally is first runtime data. The instructions alternatively or additionally are executable to obtain a first virtual state of the processing tool from the first runtime simulation of the digital twin simulated with the first runtime data from the process, obtain a second virtual state of the processing tool from a second runtime simulation of the digital twin simulated with second runtime data from a process without anomalies, compare at least a portion of the first virtual state to a corresponding portion of the second virtual state, and output one or more differences in the comparison.

### BRIEF DESCRIPTION OF THE DRAWINGS

FIG. 1 shows a block diagram of an example use environment for a virtual semiconductor fab environment.

FIG. 2 shows a block diagram illustrating an example computing system configured to operate within the virtual semiconductor fab environment of FIG. 1.

FIG. 3 depicts a flow diagram of an example method of monitoring a process utilizing a virtual semiconductor fab environment.

FIG. 4 schematically depicts an example substrate map.

FIG. 5 schematically depicts an example processing tool.

FIGS. 6A-6C schematically depict example interactions of a user with virtual states representing the process performed in the processing tool of FIG. 5.

FIG. 7 shows a block diagram illustrating example capabilities of a virtual semiconductor fab environment.

FIG. 8 shows a block diagram illustrating example security features of a virtual semiconductor fab environment.

FIG. 9 shows a block diagram illustrating an example architecture of a virtual semiconductor fab environment.

FIGS. 10A-10C show block diagrams illustrating example virtual bays for a virtual semiconductor fab environment.

FIG. 11 shows a block diagram illustrating an example manager flow schedule for a virtual semiconductor fab environment.

FIG. 12 shows a block diagram of an example computing system.

### DETAILED DESCRIPTION

The term “anomaly” and variants thereof generally represent deviations from one or more of processing conditions or substrate metrology detected during processing or after substrate processing in a processing tool.

The term “anomalous condition” generally represents a state of a processing tool that causes anomalous processing conditions and/or substrate metrology.

The term “deposition” and variants thereof generally represent a process in which a film is formed on a substrate.

The term “digital twin of a processing tool” generally represents a computer-implemented virtual representation of the processing tool. The digital twin can represent the processing tool at the tool level, a subsystem level, a component level, and/or a subcomponent level in some examples. Example subsystems include radiofrequency (RF) power subsystems, gas subsystems, thermal subsystems, mechanical subsystems, and pedestal/electrostatic chuck subsystems. The digital twin can further represent a substrate processed in the processing tool, including feature level details.

The term “etch” and variants thereof generally represent removal of material from a substrate.

The term “probable cause” generally represents a source of an anomalous condition that is sufficiently likely to have occurred during a process performed by a processing tool.

The term “processing chamber” generally represents an enclosure in which processing is performed on substrates.

The term “process model” generally represents a computer-implemented model that simulates evolution of a process over time. The process model can virtually represent a process that can be performed by a processing tool.

The term “processing tool” generally represents a machine including a processing chamber and other hardware configured to enable processes to be carried out in the processing chamber.

The term “recipe” generally represents a set of processing tool settings to implement a corresponding process on a substrate.

The term “recommended diagnostic procedure” generally represents a set of one or more tasks to be performed to gather information relating to an anomalous condition. The recommended diagnostic procedure can be manually performed by a technician or another user, or performed automatically using a computing system.

The term “reference run” generally represents data from a process performed in a processing tool which produces a desired processed substrate. Reference runs can be stored and used for later comparison against another process performed in the processing tool.

The term “runtime data” generally represents information acquired from sensors while a processing tool performs a process.

The term “runtime simulation” generally represents a computer-implemented simulation of an evolution over time of a digital twin of a processing tool performing a process.

The terms “semiconductor fab”, “fab”, and “foundry” generally represent a fabrication plant for fabricating semiconductor devices on substrates.

The term “simulated process” generally represents a computer-implemented model that simulates evolution over time of a virtual substrate based upon one or more of a recipe or runtime sensor data.

The term “simulated runtime data” generally represents computer-implemented data generated from simulating a process model.

The term “substrate” generally represents any object on which a deposition or etching process can be performed.

The term “substrate map” generally represents a value of a parameter of a substrate as a function of a location on the substrate. Substrate maps can map geometrical/topological features of a substrate. Substrate maps also can map physical and/or chemical conditions to which the substrate is exposed based upon metrology data.

The term “virtual semiconductor fab environment” generally represents a computer-implemented model of a semiconductor fab using digital twins of processing tools in the semiconductor fab.

The term “virtual experimentation” generally represents computer-implemented experiments performed on digital twins of processing tools in a virtual semiconductor fab environment.

The term “virtual state” generally represents a computer-implemented state of a digital twin of a processing tool.

The term “virtual substrate” generally represents a computer-implemented model of a substrate.

Semiconductor fabrication processes are highly complex, and can involve performing hundreds or even thousands of steps on many different tools, potentially made by different manufacturers. Further, each tool can have hundreds if not thousands of critical components that can impact on-substrate results. One of the major challenges fabs have today is how to achieve target process results on hundreds of processing tools, running hundreds of thousands of substrates per month across fabs that can be located far from one another. Further, processing tools can be expensive to own and maintain. The need to own such tools can pose a barrier to academia and/or start-up businesses who could otherwise contribute more disruptive ideas to the semiconductor technology space.

Further, the need for users to work in a physical fab poses various challenges to process development. For example, current semiconductor process design and testing can involve running many substrates through a tool or tools, for example as single variable test (SVTs) or design of experiments (DOEs). Users of the fab must dress in appropriate clean room attire, and must physically touch a tool to run substrates in the tool. Users further must research procedures for maintenance before going into the lab to work with a tool, and track all lab activity manually.

Accordingly, examples are disclosed that relate to virtual semiconductor fab environments to help address such problems. Briefly, a computing system is configured to operate a virtual semiconductor fab environment representing a physical semiconductor fab. The virtual semiconductor fab environment utilizes digital twins of one or more tools in the semiconductor fab. A digital twin of a processing tool can comprise a virtual representation of the tool, including its physical configuration, with digital representations of the various components and systems of the tool, and with logic that simulates processes performed on the tool. A digital twin can be updated in real time based upon data received from sensors residing on the physical tool modeled by the digital twin. The digital twins of the tools can be used for virtual troubleshooting, virtual experimentation, and/or other suitable workflows.

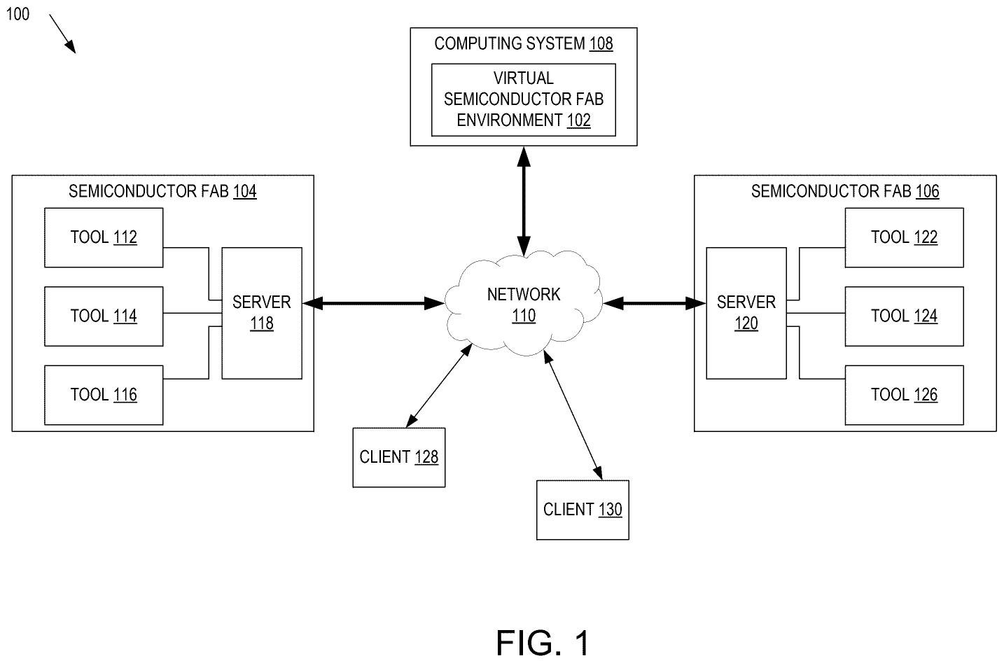

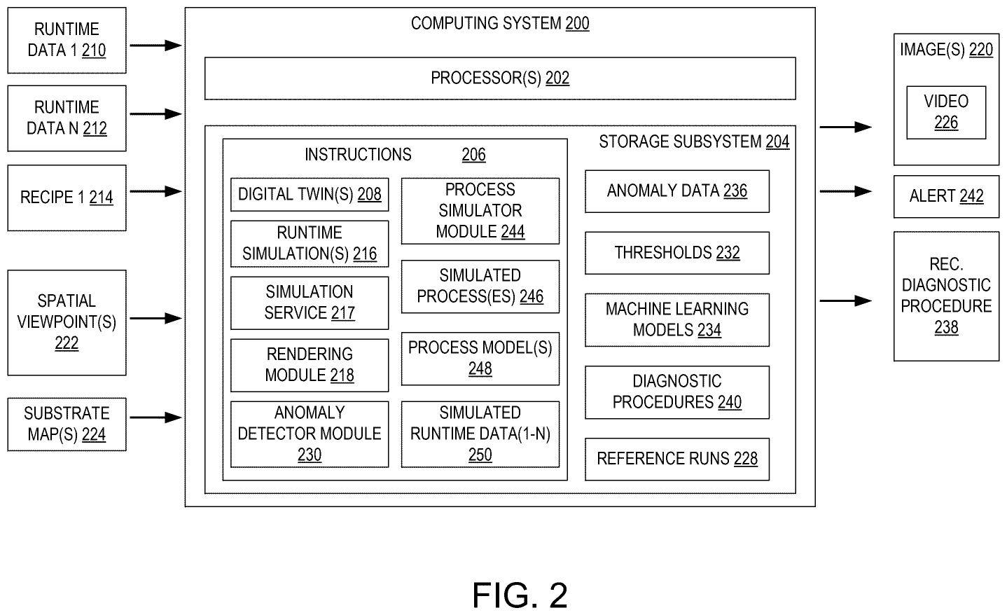

FIG. 1 shows a block diagram of an example fab network 100 utilizing a virtual semiconductor fab environment 102. Fab network 100 comprises a first semiconductor fab 104, a second semiconductor fab 106, and a computing system 108 connected to each other through a network 110, such as the internet, wide-area network (WAN), local-area network (LAN), virtual local-area network (VLAN), another network, or combinations thereof. Computing system 108 can be at least partially implemented in a data center in some examples. Computing system 108 is configured to operate a virtual semiconductor fab environment 102, as discussed in more detail with reference to FIG. 2. While two semiconductor fabs 104, 106 are shown for the purpose of illustration, a virtual semiconductor fab environment can comprise a fab network with any suitable number of semiconductor fabs.

First semiconductor fab 104 comprises a first tool 112. First tool 112 can comprise a processing tool. Example processing tools include etch tools and deposition tools. First tool 112 also can represent another tool executable in a semiconductor fab, such as a power system management tool, a substrate movement tool, etc. First semiconductor fab 104 further comprises a second tool 114 and a third tool 116. While depicted here with three tools, in other examples, first semiconductor fab 104 may comprise fewer than or more than three tools. Large fabs can comprise hundreds of tools, or even more, whereas an academic lab may have a single tool. First semiconductor fab 104 also comprises a server 118 connected to first tool 112, second tool 114, and third tool 116. As such, server 118 is configured to operatively couple first tool 112, second tool 114, and third tool 116 with each other and/or network 110. In a similar manner, fab network 100 further comprises a second semiconductor fab 106 comprising a server 120 connected to a first tool 122, a second tool 124, and a third tool 126.

As shown, fab network 100 further comprises a first client 128 connected to network 110. First client 128 can represent any suitable computing device to connect to network 110. Examples include desktop computers, tablets, laptops, wearable devices, and smart phones. In some examples, the computing device can comprise a head-mounted device configured to provide an augmented-reality (AR) or mixed-reality (MR) experience. In some such examples, a user of first client 128 can interact with a virtual representation of a semiconductor fab and/or a processing tool utilizing virtual semiconductor fab environment 102.

The user of first client 128 can utilize virtual semiconductor fab environment 102 to control and/or monitor processes and/or tools in first semiconductor fab 104 and/or second semiconductor fab 106. Further, the user of first client 128 can utilize virtual semiconductor fab environment 102 to control and/or monitor digital twins of process and or tools. Such control and monitor functions can be implemented through a virtual semiconductor fab user-interface. Such a configuration can help to enable virtual interaction with tools in fabs without being physically present in the fabs. Similarly, fab network 100 further comprises a second client 130 connected to network 110. In some examples, second client 130 can be in a different location than first client 128. While depicted with two clients, in other examples, fab network 100 can have one or more than two clients. In such a manner, fab network 100 can enable users on multiple clients in different locations to collaborate and use virtual semiconductor fab environment 102 to perform operations and/or experiments in a semiconductor fab without having the users travel to the semiconductor fab. FIG. 1 is illustrative. In other examples, fab network 100 can have another configuration in which one or more tools at one or more fabs can be remotely accessed.

FIG. 2 depicts a block diagram of an example computing system 200 configured to operate a virtual semiconductor fab environment. Computing system 200 can be connected to one or more networks (not shown). The virtual semiconductor fab environment can represent one or more physical semiconductor fabs as discussed in FIG. 1. In various examples, one or more components of computing system 200 can be collocated, distributed geographically and connected through a network, or any combination thereof. Components of computing system 200 can be located at a fab, at a cloud computing service (e.g., a data center), and/or at other institutions, such as academic institutions.

Computing system 200 comprises one or more processors 202 and a storage subsystem 204. Storage subsystem 204 comprises instructions 206 executable by the one or more processors 202 to execute various aspects of the virtual semiconductor fab environment. Examples include virtual troubleshooting and/or virtual experimentation. Instructions 206 further are executable to operate one or more digital twins 208 of a corresponding processing tool. In some examples, different subsystems of the processing tool can have different digital twins that are configured to operate as digital twins 208 of the processing tool. Such a configuration helps to enable virtual troubleshooting and/or experimentation at different subsystem levels.

Instructions 206 are further executable to obtain runtime data from processing tools. Here, example runtime data comprises runtime data 1 210 to runtime data N 212, indicating the N-1 additional runtime data. Runtime data 1 210 to runtime data N 212 represent data acquired by sensors of the processing tool while running a corresponding process 1 to process N. Example sensors can include thermal sensors, pressure sensors, gas sensors, cameras, voltmeters, ammeters, ohmmeters, and/or other suitable process sensors. Further, one or more of the sensors can comprise in-situ metrology sensors, such as cameras (e.g., a multispectral camera, such as a hyperspectral camera). In some examples, one or more of the sensors can comprise a data collection rate in the range of 1 Hz (Hertz) to a few kHz (kilohertz). In other examples, one or more of the sensors can have a data collection rate outside of this range.

Using runtime data 1 210 and a recipe 1 214 for process 1, instructions 206 are executable to perform a runtime simulation 216 by simulating digital twin 208, such as using a simulation service 217, for example. A plurality of runtime simulations 216 can be performed in some examples. Examples of runtime simulations include, but are not limited to gas flow rate simulations, RF power simulations, pressure simulations, thermal simulations, plasma simulations, deposition simulations, etching simulations, and combinations thereof.

To provide a visualization of runtime simulation 216, instructions 206 comprise a rendering module 218. Rendering module 218 is configured to render and output one or more images 220 of one or more virtual states of the processing tool using one or more runtime simulations 216 and one or more spatial viewpoints 222. Each spatial viewpoint represents a perspective of a user-controllable rendering camera within digital twin 208. The rendering camera is positioned by a user to have a selected location, direction, and field of view within digital twin 208. By changing the location, direction, and/or field of view of the rendering camera, a user can visually explore within the digital twin of the processing tool by panning, zooming, moving, etc.

Spatial viewpoints can be selected and manipulated by a user of a client device, for example. A wide variety of visualizations can be used to represent the virtual states. Example visualizations include simulated thermal images (e.g., a temperature map of the processing tool as generated using the digital twin), simulated visible image, simulated density images (e.g., plasma densities, current densities), and simulated fields (e.g., using streamlines to indicate fluid flow fields, electric fields, etc.). As a more specific example, data values of a selected type of data can be rendered using different colors or other distinctive appearances to visualize the differences in the data values. In one such example, runtime metrology data (e.g. multispectral image data) can be used to determine a film thickness as a function of substrate surface location in a deposition process (e.g. using machine learning techniques). Then, a visualization of the thickness as a function of surface location can be applied to a rendering of a substrate of a digital twin as a surface texture. In this manner, the film thickness variation can be conveniently viewed by user as a simulated visible image. Such a visualization can be referred to as a substrate map 224. A substrate map 224 generally represents metrology data as a function of substrate surface location for a substrate processed in the processing tool using a process. Rendering module 218 further can be configured to render a sequence of virtual states of the processing tool to produce a video 226 depicting evolution of the virtual state of the processing tool over time.

Instructions 206 further can be executable to perform various operations as part of a virtual troubleshooting flow. For example, instructions 206 can be executable to compare corresponding portions of virtual states of two or more runtime simulations 216. As a more specific example, instructions 206 can be executable to compare a first virtual state from a first runtime simulation for a process comprising one or more anomalies to a second virtual state from a second runtime simulation for the second process without anomalies. The comparison can help a processing tool operator to understand the possible cause(s) of the anomalies by visualizing the differences between the first runtime and the second runtime simulation. In some examples, the second runtime simulation can be stored on storage subsystem 204. For example, a runtime simulation for a process without anomalies can be performed in advance and stored in reference runs 228 for later use. This can reduce a time to obtain a runtime simulation for a process without anomalies over performing an additional runtime simulation during a troubleshooting session.

Instructions 206 also can be executable to detect anomalies in the set of runtime data. As such, instructions 206 further comprise an anomaly detector module 230 configured to detect an anomalous condition in runtime data 1 210 and/or any additional runtime data. Anomaly detector module 230 can be configured to use thresholds 232 to determine when a condition in runtime data 1 210 is outside of a threshold condition, indicating an anomalous condition. As a specific example, a gas subsystem can have an anomalous condition comprising a pressure response error. In such an example, anomaly detector module 230 can compare a pressure response of runtime data 1 210 against pressure response of reference runs 228 by applying error tolerance thresholds. Alternatively or additionally, anomaly detector module 230 can be configured to use machine learning models 234 to identify when the condition in runtime data 1 210 is an anomalous condition. Machine learning models 234 can comprise one or more of classification models, regression models, or deep learning models. In some examples, one or more of the deep learning models can also proactively determine probabilities that an anomaly may occur after a next N time steps. Here is N is used to indicate any suitable number of next steps to be performed. As a specific example, a recurrent neural network using a 10 to 20 timestamp prediction with uncertainty may reduce an uncertainty window as a specific timestamp is approached.

Upon detecting the anomalous condition, anomaly detector module 230 can determine a probable cause of the anomalous condition using data from runtime simulation 216. Further, anomaly detector module 230 can be configured to use anomaly data 236 comprising data from previously detected anomalous conditions to determine the probable cause. In the example of the pressure response error, anomaly detector module 230 can determine a probable cause of a throttle valve being out-of-spec using data from the runtime simulation with the pressure response error.

Anomaly detector module 230 further can be configured to determine a recommended diagnostic procedure 238, such as from a list of diagnostic procedures 240, for example. In the pressure response example, an example of a recommended diagnostic procedure 238 can comprise replacing the throttle valve. The anomaly detector module 230 can determine a recommended diagnostic procedure 238 in various manners. In some examples, different diagnostic procedures in a list of diagnostic procedures can be mapped to specific sets of runtime data values. In other examples, a trained machine learning function can be used to predict a diagnostic procedure that is likely to be effective in view of the runtime data. Anomaly detector module 230 also can be configured to output an alert 242 indicating the anomalous condition. In some examples, the alert 242 can indicate the recommended diagnostic procedure 238.

The instructions 206 further can be executable to implement a process simulator module 244. Process simulator module 244 is configured to perform a simulated process 246 by using a process model 248 to generate simulated runtime data 250. Process model 248 comprises a computer-implemented model of a process performed in a processing chamber of digital twin 208. Instructions 206 further can comprise additional process models 248 to perform additional simulated processes 246 and generate additional simulated runtime data 250. Using simulated runtime data 250 and a recipe for simulated process 246, a runtime simulation 216 can be performed. Such a runtime simulation can be stored in reference runs 228 for later comparison against future runtime simulations. Alternatively or additionally, such a runtime simulation can be used for process design and/or other experiments.

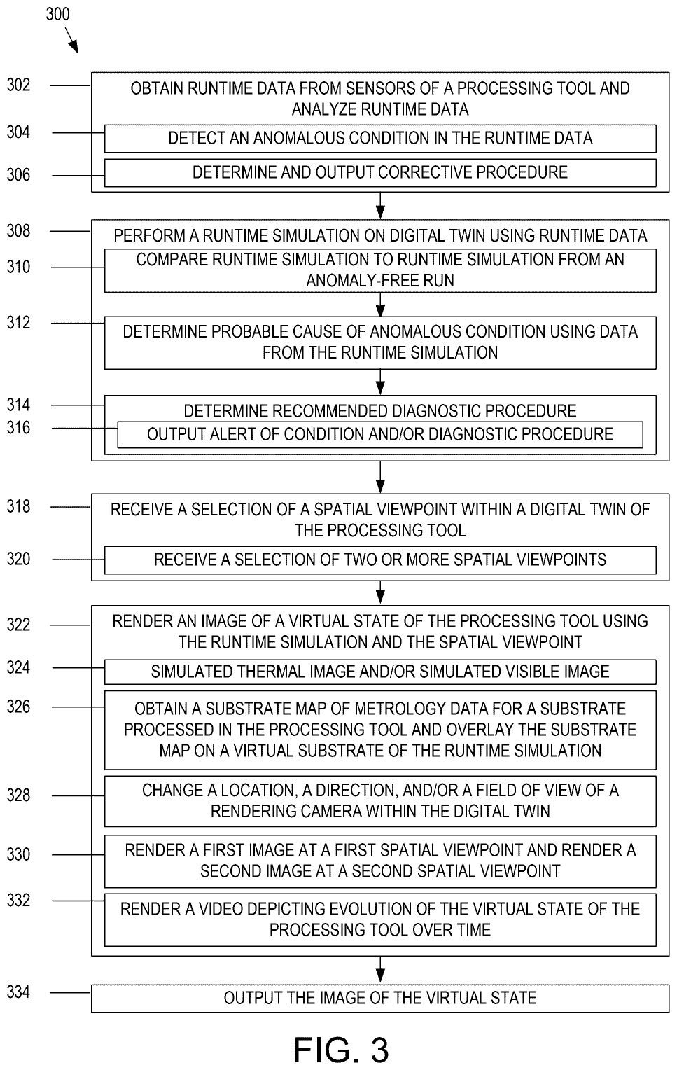

As previously mentioned, a virtual semiconductor fab environment can be used for remote operation and monitoring of a processing tool in a semiconductor fab. FIG. 3 depicts a flow diagram of an example method 300 for remotely monitoring a process performed on a substrate in a processing tool. Method 300 can be performed by computing system 200, for example. Method 300 comprises, at step 302, obtaining runtime data from sensors of the processing tool while the process is running a substrate in the processing tool, and analyzing the runtime data. The processing tool can be an etching tool, a deposition tool, or other suitable tool. In some examples, the runtime data can be obtained in real-time while the processing tool is running the process. Alternatively or additionally, in some examples, the runtime data can be stored while the process is being run on the processing tool, and then obtained after the processing tool has run at least a portion of the process.

The runtime data can be analyzed while the process is being run, and/or after the process has been run. Analyzing the runtime data can comprise, for example, comparing the runtime data to thresholds based upon a recipe for the process, and/or inputting the runtime data into a trained machine learning model. The trained machine learning model can comprise a feed-forward neural network in some examples. In such examples, the neural network can be trained using labeled training data that indicate previously acquired and/or simulated runtime data for anomalous and non-anomalous conditions. In some examples, the labeled runtime data can comprise substrate data acquired, for example, using image data such as multispectral image data. Training can be performed using backpropagation and a suitable loss function. Example loss functions include mean squared error, mean absolute error, and Huber loss.

Analyzing the runtime data can help identify an anomalous condition, as indicated at step 304. For example, where a trained machine learning model is used to analyze the runtime data, the runtime data acquired during substrate processing can be input into the trained machine learning model. The machine learning model then can output the probabilities of the occurrence of various anomalous conditions based upon the runtime data input into the machine learning model. The probabilities further can include confidence values. Based upon comparing a determined probability (and possibly confidence level) to threshold probabilities (and possibly threshold confidence levels), an anomalous condition can be determined. This can help diagnose a possible processing tool system or component that is a cause of the anomalous condition. In other examples, the runtime data can be compared to thresholds to detect anomalous conditions. In either case, the detection of anomalous conditions can be used to determine and output a recommended corrective procedure to correct for the detected anomalous operating condition, as indicated at step 306. In some examples, the anomalous condition can comprise a warning.

As described below, the runtime data, potentially along with a recipe of the process, can be used to perform a runtime simulation using a digital twin of the processing tool, as indicated at step 308. The runtime simulation produces virtual states of the processing tool. The recipe for the process specifies tool operating settings for the process. The runtime simulation can be used to render visualizations of the process for display on a client device. For example, the runtime simulation can produce data representing physical and/or chemical conditions inside of the processing tool during a process. The runtime simulation also can be used to simulate evolution of a modeled substrate subjected to conditions represented by the runtime data using a mechanistic model of the process and substrate. Such data then can be used to produce visualizations of the processing conditions and/or the modeled substrate using the digital twin of the processing tool.

The virtual state of the processing tool represents any suitable information regarding a physical state of a processing tool determined based upon the runtime data. For example, the virtual state can represent temperatures, pressures, gas flows, radiofrequency power/plasma conditions, and/or other conditions inside a processing chamber of the processing tool. The virtual state also can represent conditions of the processing tool outside of the processing chamber. As examples, the virtual state can represent vacuum/exhaust system states (e.g., temperatures and/or gas flows within an exhaust system foreline), power conditions, open/close status of panel doors, mass flow controller information, position and operating status of robots that move substrates within the processing tool, and/or any other suitable information about the processing tool.

In some examples where the runtime simulation comprises an anomalous condition, method 300 can comprise, at step 310, comparing the runtime simulation to a different runtime simulation from an anomaly-free run. For example, a first virtual state of the processing tool as determined from the runtime simulation can be compared to a second virtual state from a second runtime simulation representing a process without anomalies. In some such examples, the second runtime simulation can be a reference run. The reference run can be a prior anomaly-free run on the same processing tool, or a prior anomaly-free run on a different processing tool of the same processing tool type. The reference run further can be a modeled process. After comparing at least a portion of the first virtual state to a corresponding portion of the second virtual state, one or more differences based upon the comparison can be outputted to a client device. Method 300 can help to enable monitoring and/or troubleshooting of a process performed in a process tool for engineers in different locations.

In examples where anomalous operating conditions are detected in a runtime simulation, method 300 further can comprise, at step 312, determining a probable cause of the anomalous condition using data from the runtime simulation. In some examples, a trained machine learning model can be used to determine the probable cause. Example machine learning functions and training methods are described above. In other examples, probable causes can be mapped to thresholds that define anomalous operating conditions. For example, a threshold pressure that defines an anomalous pressure can be mapped to an exhaust system valve. Method 300 further can optionally comprise determining a recommended diagnostic procedure at step 314. Method 300 can additionally comprise outputting the diagnostic procedure and/or an alert indicating the anomalous condition at step 316. The recommended diagnostic procedure can be computer implemented, human implemented, or any combination thereof.

As a more specific example, where an anomaly related to a vacuum system is detected, the recommended diagnostic procedure can involve collecting infrared (IR) data for a vacuum system foreline to see if temperature could possibly result in particle accumulation and clogging of the foreline. IR sensors in the processing tool can be used collect the IR data. Alternatively or additionally, a technician can use a handheld IR camera to gather the IR data. As another more specific example. where an anomalous condition comprising a warning in an RF subsystem is detected, metrology data may indicate that processed substrates are drifting low on thickness values. A runtime simulation of the digital twin of the RF subsystem may be used to determine that a misaligned showerhead generates data indicating that a modeled process substrate has similarly low thickness values. As such, a recommended diagnostic procedure of tuning the showerhead and performing a cleaning procedure can be output.

The virtual state of a processing tool as determined from a runtime simulation using a digital twin can be visualized from any chosen viewpoint within the digital twin. Thus, method 300 further comprises, at step 318, receiving a selection of a spatial viewpoint within the digital twin of the processing tool. The selected spatial viewpoint represents a location, a direction, and an angular field of view of a rendering camera used to render a visualization of the virtual state selected. The selection can be made, for example, by outputting a rendering of a model of the processing tool (e.g., a physical model of the tool from the digital twin), and receiving a user input (e.g., by touch, mouse click, or other) of a location within the rendering of the processing tool.

The visualization of the digital twin from the selected spatial viewpoint can be rendered using computer graphics rendering methods. Three-dimensional locations within the digital twin can represent modeled physical structures of the processing tool. Further, runtime simulation data can be mapped to the three-dimensional locations within the digital twin for visual representation. In some examples, two or more viewpoints can be presented at one time, such as in different windows in a display user interface. Thus, in such examples, receiving the selection of the spatial viewpoint within the digital twin comprises receiving a selection of two or more spatial viewpoints, as indicated at step 320.

Method 300 further comprises rendering an image of a virtual state of the processing tool using the runtime simulation and the spatial viewpoint at step 322. In some examples, the image can comprise one or more of a simulated thermal image or a simulated visible image, as indicated at 324. A simulated thermal image can visually represent infrared data acquired, for example, by an infrared or multispectral camera at different locations in a processing tool. A simulated thermal image also can represent temperatures sensed at other temperature sensors within a processing tool. Interpolation, for example, can be used to determine temperatures between sensor locations. A simulated visible image can represent physical structures within a processing tool during a process. Images also can be rendered to represent other sensed conditions, such as pressure and gas flows within the tool. Such images representing sensed conditions can be presented as an overlay over, or otherwise composited with, images of the digital twin. In such examples, different colors can be used to represent different values of a sensed condition.

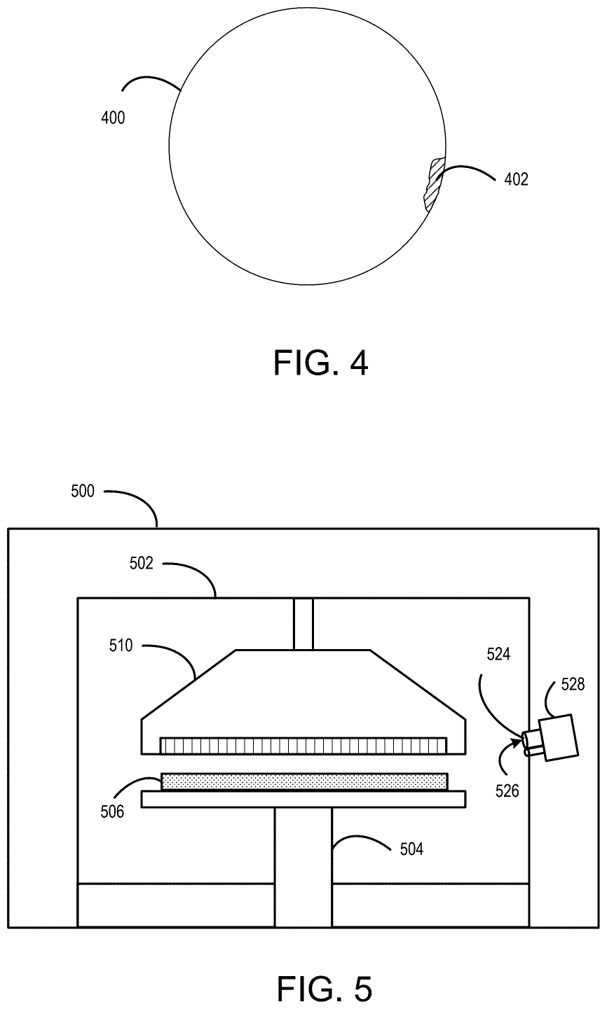

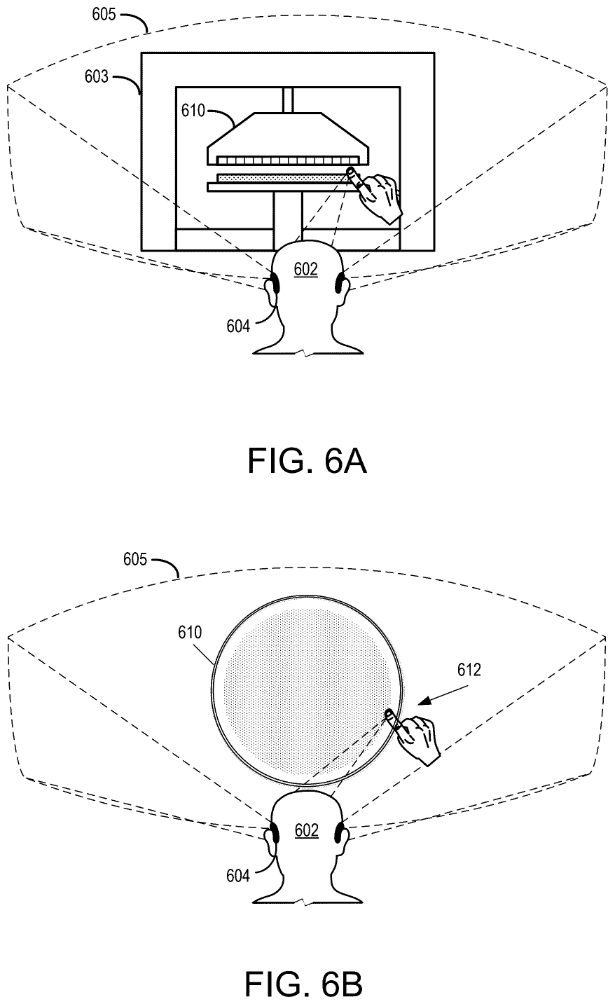

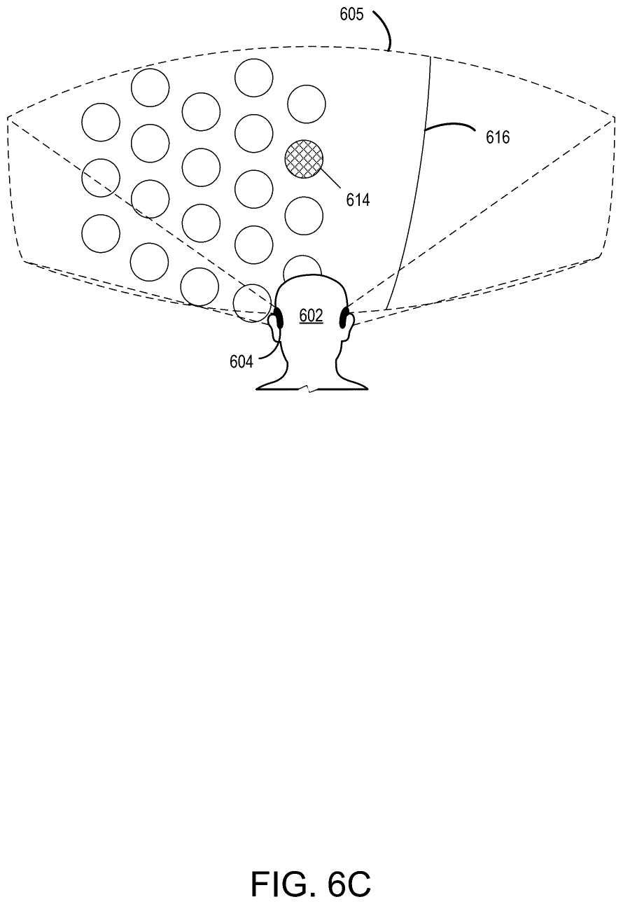

A user of a client device further can select a type of data to visualize. For example, at step 326, method 300 can comprise obtaining a substrate map of metrology data for the substrate processed in the processing tool using the process. Method 300 further can comprise overlaying a representation of the substrate map of the metrology data on a virtual substrate of the runtime simulation. An example of a substrate map 400 is schematically depicted in FIG. 4. Substrate map 400 comprises information of a thickness of a film deposited on a substrate across the substrate. In the depicted example, substrate map 400 further comprises a thickness anomaly 402 as will be discussed with reference to FIGS. 6A-6C. Substrate map 400 can be produced using data from a processing tool comprising an image sensor configured to sense film thickness. An example processing tool 500 comprising an image sensor is schematically depicted in FIG. 5. Processing tool 500 comprises a processing chamber 502 and a pedestal 504 within processing chamber 502. Pedestal 504 is configured to support a substrate 506 disposed within processing chamber 502. Processing tool 500 further comprises a showerhead 510 in which process gasses flow into processing chamber 502.

Processing chamber 502 further comprises an optical interface 526 disposed on a sidewall 524 of processing chamber 502. Optical interface 526 is an interface that can pass desired wavelength bands of electromagnetic radiation from an interior of processing chamber 502 to a hyperspectral camera 528 located external to processing chamber 502 while preventing the passage of gases. In the depicted example, optical interface 526 comprises an optically transparent window positioned in an aperture formed in sidewall 524 of processing chamber 502. Processing tool 500 also comprises a multispectral camera 528 (e.g. a hyperspectral camera) arranged to capture hyperspectral images of a substrate within a processing chamber 502 through optical interface 526 of processing chamber 502. FIG. 5 is illustrative. In other examples, a processing tool can have another configuration.

Returning to FIG. 3, t runtime multispectral image data can be input into a trained machine learning function that is trained to predict a film thickness at each image pixel of a multispectral image data. The predicted film thickness data at each image pixel then can be mapped to a corresponding color or other visually distinct effect. The colors (or other effect) then can be applied as a texture map in the rendering of an image of a substrate model in the digital twin of the tool to produce a substrate map (such as substrate map 400) illustrating film thicknesses across a surface of the substrate (such as substrate 506).

A user of a client device can operate the client device to control the location, direction, and/or field of view of the rendering camera within the digital twin, as indicated at step 328. As a more specific example, a user can change the location and/or direction of the rendering camera to visualize different components within the processing tool. The user further can change the field of view to control the magnification of the image at the spatial viewpoint. Referring to the above film thickness substrate map example 400, a user 602 can use a processing tool digital twin 603 to understand the possible cause of thickness anomaly 402 in film thickness substrate map 400. Here, processing tool digital twin 603 is a digital twin of processing tool 500. As one possible cause, a film thickness anomaly can arise from a hollow cathode discharge in a showerhead outlet hole. However, the interior of the showerhead outlet hole can be occluded from a camera view due to the perspective of the camera (e.g., multispectral camera 528). Thus, user 602 can use the runtime data from the process that produced the thickness anomaly to view a runtime simulation of processing tool 500, including showerhead 510, during a process in which the runtime data was captured. More specifically, in FIG. 6A, a user 602 of a client device 604 (depicted here as a head-mounted display device with a display field of view 605) selects to view a virtual state of a showerhead digital twin 610 within processing tool digital twin 603. The user selects the location by using eye gaze to target the location (indicated by dashed gaze lines), combined with a hand gesture to confirm the selection of the location and redirect the rendering camera to face upwardly at the selected location. Alternatively or additionally, user 602 can select the location by using audio input, such as a voice command, for example. In response, referring to FIG. 6B, a location of a rendering camera within the digital twin updates based upon the user input, such that showerhead digital twin 610 is in a field of view from the thickness anomaly. User 602 of client device 604 can then select a spatial viewpoint at a location of the thickness anomaly on the thickness map. In the depicted example, user 602 selects a location 612 on showerhead digital twin 610 corresponding to the location of thickness anomaly 402 on substrate map 400. Further, user 602 can change the field of view of the rendering camera to magnify an area of showerhead digital twin 610 over thickness anomaly 402, as depicted in FIG. 6C. In this manner, user 602 can view whether a hollow cathode discharge 614 within an outlet hole of a showerhead can be seen in the virtual state of showerhead digital twin 610. In such a manner, based upon the runtime data (e.g., metrology data, voltage/current data, or acquired by a visible camera), user 602 of client device 604 views a simulation of a hollow cathode discharge 614 within an outlet hole of the digital twin of the showerhead that is located adjacent to an edge 616 of the digital twin of the showerhead. This can provide an indication that the hollow cathode discharge 614 may indeed have been the cause of the thickness anomaly 402. While the client device is depicted as a head-mounted augmented reality or virtual reality display device in FIGS. 6A-6C, in other examples other types of client devices can be used. Examples include desktop computers, laptop computers, tablet computers, and smart phones.

As another example, continuing with the film thickness substrate map example, a user can first view a visualization of an entire substrate to view a thickness map of the substrate from a distance. Then, the user can zoom onto specific substrate areas to view the areas in more detail. In some examples, the user can zoom to a feature level of the substrate. This can allow the user to view evolution of a film on a substrate at a substrate feature level through the runtime simulation. This can be used, for example, to help understand variation in feature shape as a function of feature location on the substrate.

Returning to FIG. 3, in examples where the selection of two or more spatial viewpoints are received, method 300 comprises rendering a first image of the virtual state at a first spatial viewpoint and rendering a second image of the virtual state at a second spatial viewpoint, as indicated at step 330. In such examples, a user can control each of the first rendered image, the second rendered image, and any additional rendered images separately. This can be used to provide a side-by-side view of different locations in the digital twin for comparison. As a more specific example, one window could be used to visualize processing gas flows within a processing chamber, while another could be used to visualize a vacuum system valve at a same point in time within the simulation. This can allow an effect of valve performance on processing chamber conditions to be observed using runtime data simulated with the digital twin.

The runtime simulations can be updated at any suitable frame rate. The updated runtime simulations can be mapped to the digital twin to produce a sequence of video image frames that represent evolution of the processing tool state over time. Thus, method 300 further comprises rendering video data depicting evolution of the virtual state of the processing tool over time at step 332. The video can utilize a single spatial viewpoint and/or a selection of changing spatial viewpoints over time.

Method 300 further comprises, at step 334, outputting the image (still or video) of the virtual state. The image can be displayed on one or more display devices. In such a manner, two or more engineers at different locations can concurrently view the image and collaborate, and thereby enabling the engineers to troubleshoot issues without traveling to the semiconductor fab. In other examples, the image can be stored for later display. Method 300 can help to enable monitoring and/or troubleshooting of a process performed in a process tool for engineers in different locations.

In some examples, users of a virtual semiconductor fab environment can use virtual reality (VR) and/or augmented reality (AR) devices to present and interact with the virtual semiconductor fab environment to train on digital twins of tools and/or perform tasks on a tool by interacting with the digital twin of the tool, without physically touching the tool. A VR device can take the form of head-mounted devices that present an immersive, fully virtual experience to a user. An AR device can comprise a see-through display that allows the display of virtual imagery over a view of a real-world environment. Mixed reality (MR) devices are types of AR devices that present virtual objects as if they were physically present in the environment of the user. For example, a MR device can use stereoscopic imaging to display virtual objects with realistic distance effects. Further, an MR device can utilize on-device sensors (e.g., one or more cameras configured to acquire depth images) to create a depth map of the environment, such as a mesh representation of surfaces in the environment. This can allow the display of virtual objects intermixed with real objects using realistic occlusion effects.

As mentioned above, a digital twin for a processing tool can be provided in a virtual semiconductor fab environment. This can allow a user accessing the virtual semiconductor fab environment using AR or VR to virtually use a tool in the virtual semiconductor fab environment. The user can learn a physical configuration of the tool, interact with the tool using virtual user interfaces, and/or run simulations using the digital twin. Further, where the digital twin is configured to receive real-time data regarding the tool, the user can observe, and control, a real-time state of the tool utilizing AR or VR and the digital twin. Digital twins of individual tool components, such as RF power generators, robotics, and mass flow controllers, can be incorporated into the digital twin of a tool.

Digital twins of individual tools can be incorporated into a virtual semiconductor fab environment, with digital twins of different tools arranged spatially within a three-dimensional virtual environment modeling a physical semiconductor fab. Further, individual semiconductor fabs can be arranged into a network of fabs. This can allow the creation of an innovation ecosystem without boundaries and/or borders, filled with virtual hardware that comprises always-on virtual representations of each fab, including all the tools inside (e.g., etch and/or deposition tools), not only at the system level, but also at the subsystem level, with representations of components, such as RF power generators, mass flow controllers, and/or robotics, for example. Digital twins representing tools in individual, physical fabs allow the individual fabs to be turned into data-sharing, innovation powerhouses where breakthrough ideas can be drawn from anywhere. By interconnecting innovation centers that use the individual fabs on a large scale, semiconductor industry companies, start-ups, researchers, and/or students from all over the world can access equipment and run experiments without having to be physically present. This can facilitate creativity and problem-solving by allowing for unprecedented ecosystem-wide collaboration designed to deliver disruptive technologies faster and more often. This also can provide savings in time and/or money by shortening development cycles and/or leveraging the investment already made in existing infrastructure. These factors and potentially others can facilitate brainstorming and fast turn concept validation, and/or reduce the time it takes from technology ideation to commercialization.

A virtual semiconductor fab comprising digital twins of tools within a corresponding physical fab can allow simulations of processes to be run to validate processing strategies before heading into a lab to run experiments. As mentioned above, each digital twin is configured to implement virtual processes. Such virtual process modeling can help process researchers and designers understand what is happening at a substrate level—at the microscopic scale where devices on the chips are built. In a physical process design, a real substrate would be physically moved from one specialized processing reactor to another. However, with digital twins configured to implement virtual processes, a fabrication process involving a single tool or multiple tools can be simulated at a nanometer scale to see how a structure develops over time in the processing tool(s). Such simulations can allow research projects that used to cost millions of dollars to be performed at a lower cost.

With a full virtual representation of an entire fab, a virtual semiconductor fab environment can model fab output and throughputs of different tools. Given the tight specifications under which semiconductor fabs must operate, the virtual modeling of hardware and processes can help a fab to replicate and maintain a determined optimal process.

Digital twins of processing tools also can be used to facilitate the processing of physical substrates in tools. A virtual fab can provide operators a portal to digitally access data from, and controls for controlling, physical tools represented by digital twins in the virtual fab. Such a portal can allow users to schedule substrates, check tool health, view chambers, view a fleet of tools, and much more, all from one location. The fleet of tools can represent tens or hundreds of tools from a same family running a same process as part of a semiconductor device volume manufacturing. In the example of deposition tools, levels of grouping of the deposition tools include one module (e.g., contains 4 stations), one tool (e.g., contains 3 to 5 modules depending on a configuration), and a fleet of tools (e.g., a same family of tools). In a semiconductor fab, many fleets of tools are designed to do the same process, such as many etching tools for one application or deposition tools for a different application, for example. Further, a digital twin can utilize artificial intelligence to learn how process parameters affect process outcome. Such artificial intelligence can be used to provide procedures to a user interface (UI), thereby simplifying the step process. Further, the use of a digital twin to monitor and control a tool can provide safety benefits. By allowing users to interact with digital twins of tools in a semiconductor fab using a virtual representation of the fab, human risks, human errors, and environmental impacts can be reduced. Additionally, records of tool use can be maintained using a blockchain substrate ledger in some examples.

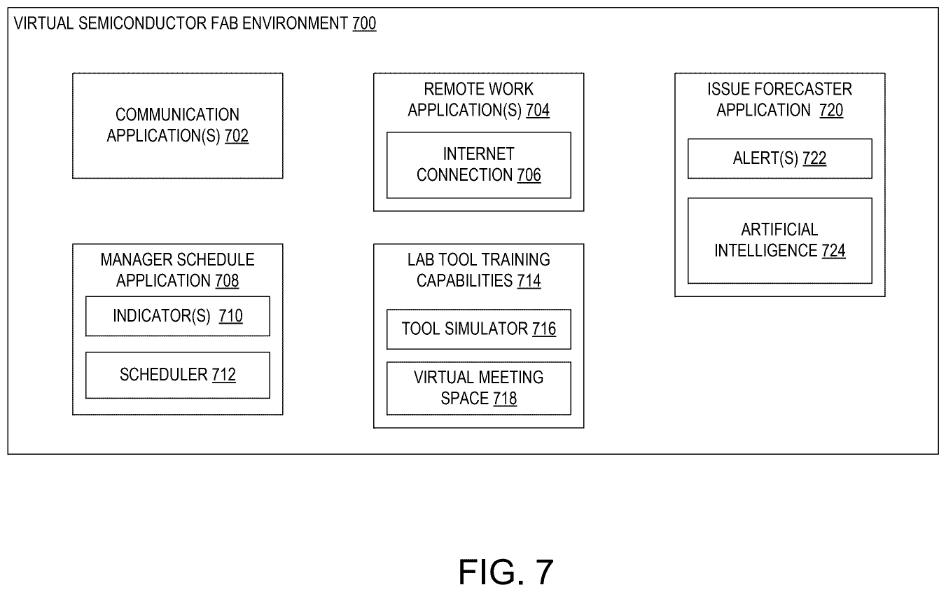

FIG. 7 shows a block diagram illustrating example capabilities of an example virtual semiconductor fab environment 700. Virtual semiconductor fab environment 700 is an example of virtual semiconductor fab environment 102. Virtual semiconductor fab environment 700 comprises one or more communication applications 702 that provide for such communication modes as text chat and proximity chat, among other communications modes. Virtual semiconductor fab environment 700 further comprises one or more remote work applications 704. For example, a VR or AR headset application can connect to the virtual semiconductor fab environment 700 from a remote location with an internet connection 706. Additionally, virtual semiconductor fab environment 700 comprises a manager scheduler application 708, where users can view indicators 710 on tool status, such as tool uptime and/or progress. The manager scheduler application 708 further comprises a scheduler 712 configured to allow the user to schedule further processes while connected remotely. Virtual semiconductor fab environment 700 also comprises lab tool training capabilities 714. For example, a lab tool training application (depicted here as a tool simulator 716) is configured to enable employees to train using simulations of the tools to understand tool functionalities. Further, users can meet virtually to learn, plan, and strategize as a team by using virtual meeting space 718. Virtual semiconductor fab environment 700 additionally comprises an issue forecaster application 720 configured to alert 722 users about upcoming maintenance tasks. Further, artificial intelligence 724 (such as machine learning models, for example) can be used to determine when predictive maintenance routines can be needed. FIG. 7 is illustrative. In other examples, a virtual semiconductor fab environment can omit one or more components shown and/or comprise additional components.

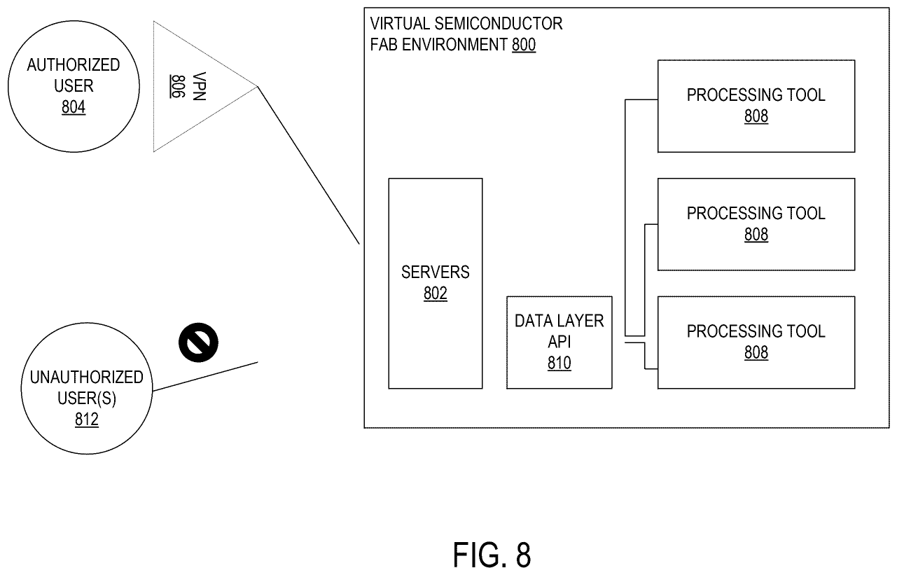

FIG. 8 shows a block diagram illustrating example security features of a virtual semiconductor fab environment 800. Virtual semiconductor fab environment 800 is an example of virtual semiconductor fab environment 102. Virtual semiconductor fab environment 800 comprises servers 802 located behind a facility virtual local area network (VLAN) where only authorized users 804 can access using a virtual private network (VPN) 806. Further, permissioned logins can be entered to gain access for specific sessions. After access is granted to authorized user 804, authorized user 804 can access one or more of processing tools 808 through a data layer application platform interface (API) 810. As shown, unauthorized users 812 are not granted access to servers 802. FIG. 8 is illustrative. In other examples, a virtual semiconductor fab environment can use another configuration.

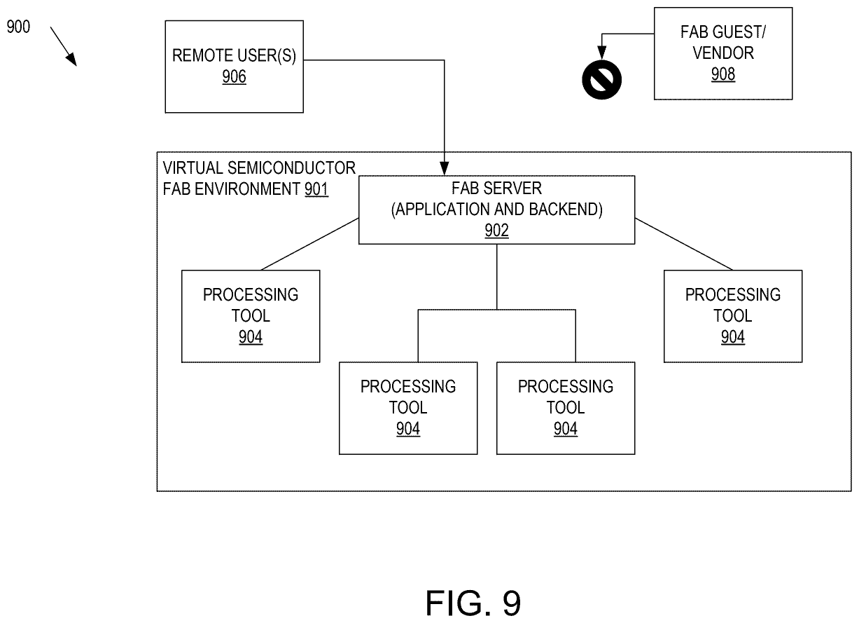

FIG. 9 shows a block diagram illustrating an example architecture 900 of a virtual semiconductor fab environment 901. Virtual semiconductor fab environment 901 is an example of virtual semiconductor fab environment 102. Virtual semiconductor fab environment 901 comprises a fab server 902 operatively coupled to a plurality of processing tools 904. Remote users 906 can connect to fab server 902 to interact with one or more of the plurality of processing tools 904. Specifically, with the illustrated architecture 900, one or more remote users 906 can upgrade tool software and/or firmware automatically, without technicians having to work on the tool in person. This can help to facilitate “lights out manufacturing/production” (e.g., fully automated production). Architecture 900 can enable short install turnaround times by utilizing updatable patches. The installation further is secure, and can be customizable. As shown, a fab guest/vender 908 does not have access to fab server 902. FIG. 9 is illustrative. In other examples, a virtual semiconductor fab environment can have another configuration.

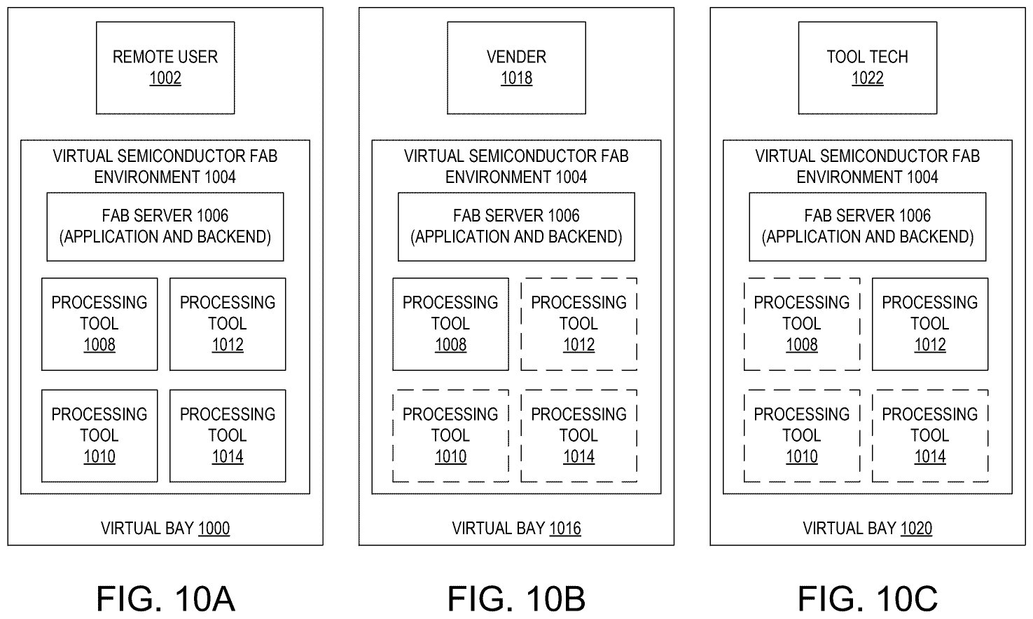

FIGS. 10A-C show block diagrams illustrating example virtual bays for a virtual semiconductor fab environment. Virtual “work bays” can be created for different types of users. In FIG. 10A, a first virtual bay 1000 is configured for a remote user 1002 (e.g., employee of the fab) to use virtual semiconductor fab environment 1004. Virtual semiconductor fab environment 1004 comprises a fab server 1006 and a plurality of digital twins. In the depicted example, the plurality of digital twins represents a first processing tool 1008, a second processing tool 1010, a third processing tool 1012, and a fourth processing tool 1014. In other examples the plurality of digital twins can represent one, two, three, or more than four processing tools. In the depicted example, a remote user 1002 has access to first, second, third, and fourth processing tools 1008, 1010, 1012, and 1014 in first virtual bay 1000. Alternatively, service providers can service physical tools remotely using virtual semiconductor fab environment 1004. Virtual bays can be created for specific service providers, and can be used to grant only those permissions needed to perform service to a selected tool or tools, while denying access to other tools. In FIG. 10B, a second virtual bay 1016 is configured for use by a vender 1018. Here, second virtual bay 1016 is configured to allow access to first processing tool 1008 for vendor 1018. Further, vender cannot access second, third, and fourth, processing tools 1010, 1012, 1014. Similarly, a third virtual bay 1020 is configured to allow access to third processing tool 1012 for a tool technician 1022, as shown in FIG. 10C. FIGS. 10A-10C are illustrative. In other examples, a virtual bay and/or virtual semiconductor fab environment can have another configuration.

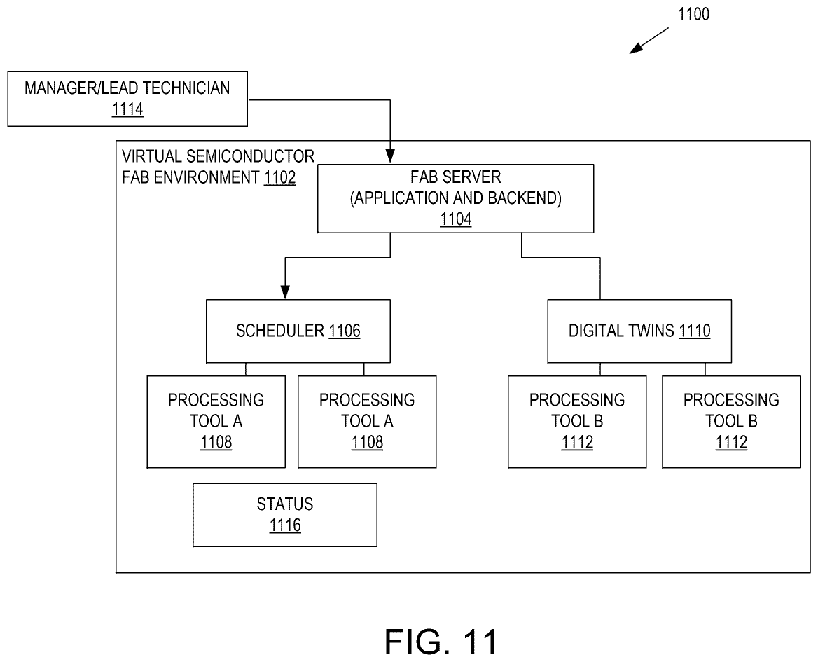

FIG. 11 shows a block diagram illustrating an example manager flow schedule 1100 for a virtual semiconductor fab environment 1102. Virtual semiconductor fab environment 1102 comprises a fab server 1104 connected to a scheduler 1106. Scheduler 1106 is configured to control processing tools 1108. Fab server 1104 is connected to digital twins 1110 of processing tools 1112. In this example, a manager/lead technician 1114 can manage the operations of processing tools from multiple providers using fab server 1104. Further, manager/lead technician 1114 can view a status 1116 of processing tools 1108.

A virtual semiconductor fab environment system can provide many other possible applications to users. One example application comprises a meeting portal that provides a meeting room format, scenario planning, and a location for other activities. Another example application comprises a virtual semiconductor fab environment portal. This portal can have a fab room format. Permissions are controlled by an administrator, who can allow users to view tools on an as-needed basis, for example. Another example application comprises a tool explorer. A tool explorer can allow a user to review tool parts and connectivity (e.g., 3D model viewing), can perform machine learning (recipe optimization), can perform procedures/repair-related machine learning (preventive maintenance, predictive maintenance), can provide live tool operation status, and substrate scheduling capabilities. Another example application comprises a substrate ledger application that tracks information both at a tool level and at a substrate level. Another example application comprises a virtual semiconductor fab environment administration panel. The virtual semiconductor fab environment administration panel can provide a tool for setting up automatic jobs to be run, and allow security configurations to be set and modified.

A user can connect to a virtual semiconductor fab in any suitable manner. For example, a user of a VR or AR headset (or other suitable computing device, such as a laptop computer, desktop computer, tablet computer, etc.) can connect to a local host (e.g., a laptop or desktop device), which can authenticate the user. The user then selects a virtual semiconductor fab client application, which opens a launcher that allows the user to enter and experience the virtual semiconductor fab environment.

A virtual semiconductor fab environment can provide various advantages compared to interacting with individual tools physically in a fab. For example, the use of the virtual semiconductor fab environment can allow for increased productivity, with user interaction and machine learning assistance, automatic substrate run scheduling and delivery, an enjoyable work environment approach, and artificial intelligence (AI) for recipe optimization and predictive maintenance. The virtual semiconductor fab environment also can provide for cost reductions. For example, the use of a virtual semiconductor fab environment can provide for less travel time for employees, fewer physical seats in company locations, and less electricity use due to reduced facility occupancy. A virtual semiconductor fab environment as disclosed also can provide for reduced exposures to lab hazards. Further, if a lab hazard alert occurs, there are fewer or no people to evacuate. For example, a reduced number of employees responsible for clearing any alerts may be the only people in the fab during operation. Further, other employees can continue to perform remote work using the virtual semiconductor fab environment. The virtual semiconductor fab environment also can provide for increased social interaction, as employees can discuss and work in the same virtual space. This can provide for a smaller gap of communication for managers, as managers and employees can enter a same workspace and discuss.

In some embodiments, the methods and processes described herein can be tied to a computing system of one or more computing devices. In particular, such methods and processes can be implemented as a computer-application program or service, an application-programming interface (API), a library, and/or other computer-program product.

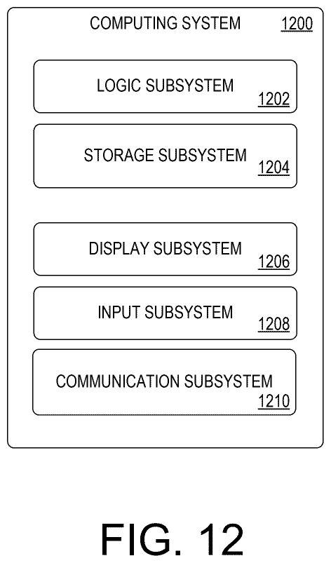

FIG. 12 schematically shows a non-limiting embodiment of a computing system 1200 that can enact one or more of the methods and processes described above. Computing system 1200 is shown in simplified form. Computing system 1200 can take the form of one or more personal computers, server computers, tablet computers, home-entertainment computers, network computing devices, gaming devices, mobile computing devices, mobile communication devices (e.g., smart phone), and/or other computing devices. Computing system 1200 can represent any computing system within a virtual semiconductor fab environment, including computing systems on processing tools, virtual semiconductor fab environment servers that are located within fabs and/or in remote data centers, and user client devices, such as AR and VR devices that comprise client applications for interacting with a virtual semiconductor fab environment. Computing system 200 and client device 604 are examples of computing system 1200.

Computing system 1200 includes a logic subsystem 1202 and a storage subsystem 1204. Computing system 1200 can optionally include a display subsystem 1206, input subsystem 1208, communication subsystem 1210, and/or other components not shown in FIG. 12.

Logic subsystem 1202 includes one or more physical devices configured to execute instructions. For example, the logic machine can be configured to execute instructions that are part of one or more applications, services, programs, routines, libraries, objects, components, data structures, or other logical constructs. Such instructions can be implemented to perform a task, implement a data type, transform the state of one or more components, achieve a technical effect, or otherwise arrive at a desired result.

The logic machine can include one or more processors configured to execute software instructions. Additionally or alternatively, the logic machine can include one or more hardware or firmware logic machines configured to execute hardware or firmware instructions. Processors of the logic machine can be single-core or multi-core, and the instructions executed thereon can be configured for sequential, parallel, and/or distributed processing. Individual components of the logic machine optionally can be distributed among two or more separate devices, which can be remotely located and/or configured for coordinated processing. Aspects of the logic machine can be virtualized and executed by remotely accessible, networked computing devices configured in a cloud-computing configuration.

Storage subsystem 1204 includes one or more physical devices configured to hold instructions executable by the logic machine to implement the methods and processes described herein. When such methods and processes are implemented, the state of storage subsystem 1204 can be transformed—e.g., to hold different data.

Storage subsystem 1204 can include removable and/or built-in devices. Storage subsystem 1204 can include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1204 can include volatile, nonvolatile, dynamic, static, read/write, read-only, random-access, sequential-access, location-addressable, file-addressable, and/or content-addressable devices.

It will be appreciated that storage subsystem 1204 includes one or more physical devices. However, aspects of the instructions described herein alternatively can be propagated by a communication medium (e.g., an electromagnetic signal, an optical signal, etc.) that is not held by a physical device for a finite duration.

Aspects of logic subsystem 1202 and storage subsystem 1204 can be integrated together into one or more hardware-logic components. Such hardware-logic components can include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1206 can be used to present a visual representation of data held by storage subsystem 1204. This visual representation can take the form of a graphical user interface (GUI). As the herein described methods and processes change the data held by the storage machine, and thus transform the state of the storage machine, the state of display subsystem 1206 can likewise be transformed to visually represent changes in the underlying data. Display subsystem 1206 can include one or more display devices utilizing virtually any type of technology. Such display devices can be combined with logic subsystem 1202 and/or storage subsystem 1204 in a shared enclosure, or such display devices can be peripheral display devices.

When included, input subsystem 1208 can comprise or interface with one or more user-input devices such as a keyboard, mouse, touch screen, or game controller. In some embodiments, the input subsystem can comprise or interface with selected natural user input (NUI) componentry. Such componentry can be integrated or peripheral, and the transduction and/or processing of input actions can be handled on-or off-board. Example NUI componentry can include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1210 can be configured to communicatively couple computing system 1200 with one or more other computing devices. Communication subsystem 1210 can include wired and/or wireless communication devices compatible with one or more different communication protocols. As non-limiting examples, the communication subsystem can be configured for communication via a wireless telephone network, or a wired or wireless local- or wide-area network. In some embodiments, the communication subsystem can allow computing system 1200 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein can represent one or more of any number of processing strategies. As such, various acts illustrated and/or described can be performed in the sequence illustrated and/or described, in other sequences, in parallel, or omitted. Likewise, the order of the above-described processes can be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method of monitoring a process performed on a substrate in a processing tool, the method comprising:
obtaining runtime data from sensors of the processing tool while running the process in the processing tool;
performing a runtime simulation by simulating a digital twin using the runtime data and a recipe for the process;
receiving a selection of a spatial viewpoint within the digital twin of the processing tool;
rendering an image of a virtual state of the processing tool using the runtime simulation and the spatial viewpoint; and
outputting the image of the virtual state.

2. The method of claim 1, wherein receiving the selection of the spatial viewpoint within the digital twin comprises receiving a selection of two or more spatial viewpoints, and wherein rendering the image of the virtual state of the processing tool comprises rendering a first image of the virtual state at a first spatial viewpoint and rendering a second image of the virtual state at a second spatial viewpoint.

3. The method of claim 1, wherein rendering the image of the virtual state of the processing tool comprises changing one or more of a location, a direction, or a field of view of a rendering camera within the digital twin.

4. The method of claim 1, wherein rendering the image of the virtual state of the processing tool comprises rendering a video depicting evolution of the virtual state of the processing tool over time.

5. The method of claim 1, wherein the image comprises one or more of a simulated thermal image, a simulated visible image, a simulated density image, or a simulated field.

6. The method of claim 1, further comprising obtaining a substrate map of metrology data for the substrate processed in the processing tool using the process, and wherein rendering the image of the virtual state of the processing tool further comprises overlaying a representation of the substrate map of the metrology data on a virtual substrate of the runtime simulation.

7. The method of claim 1, wherein the runtime simulation is a first runtime simulation for a process comprising one or more anomalies, the virtual state is a first virtual state, the runtime data is first runtime data, and the method further comprises
obtaining a second virtual state of the processing tool from a second runtime simulation of the digital twin simulated with second runtime data from a process without anomalies;
comparing at least a portion of the first virtual state to a corresponding portion of the second virtual state; and
outputting one or more differences based upon the comparison.

8. A computing device, comprising:
a display subsystem;
a logic subsystem; and
a storage subsystem comprising instructions executable by the logic subsystem to
receive a user input selecting a spatial viewpoint within a digital twin of a processing tool,
receive a user input selecting a set of runtime data acquired by the processing tool,
provide the user input selecting the spatial viewpoint and the user input selecting the set of runtime data to a simulation service of a virtual semiconductor fab environment,
receive, from the simulation service, data from a runtime simulation that represents a virtual state of the processing tool using the digital twin, and
display a rendered image of the virtual state from the spatial viewpoint selected.

9. The computing device of claim 8, wherein the instructions to receive the user input selecting the set of runtime data acquired by the processing tool comprise instructions executable to receive user inputs of a plurality of different spatial viewpoints, and wherein the instructions executable to display the rendered image of the virtual state from the spatial viewpoint comprise instructions executable to display rendered images from the plurality of different spatial viewpoints.

10. The computing device of claim 8, wherein the instructions are further executable to receive an input changing one or more of a location, a direction, or a field of view of a rendering camera within the digital twin, and to display an updated rendered image of the virtual state after changing the one or more of the location, the direction, or the field of view.

11. The computing device of claim 8, wherein the computing device comprises a head-mounted display device.

12. The computing device of claim 11, wherein the instructions executable to receive the user input selecting the spatial viewpoint comprise instructions executable to receive user input by one or more of a head-tracking camera, a microphone, or an eye-tracking camera.

13. The computing device of claim 8, wherein the virtual state comprises a substrate map, and wherein the instructions executable to display the rendered image of the virtual state comprise instructions executable to display the substrate map over a virtual substrate.

14. The computing device of claim 8, wherein the instructions are further executable to
receive a notification of an anomaly in the set of runtime data, and
in response, display the notification.

15. A computing system, comprising:
a logic subsystem comprising one or more processors; and
a storage subsystem comprising instructions executable to operate a digital twin of a processing tool, the storage subsystem also comprising instructions executable by the one or more processors to
obtain runtime data from the processing tool, the runtime data comprising data acquired by sensors of the processing tool while running a process in the processing tool,
detect an anomalous condition in the runtime data,
in response to detecting the anomalous condition, perform a runtime simulation by simulating the digital twin using one or more of the runtime data or a recipe for the process, and
determine a probable cause of the anomalous condition using data from the runtime simulation.

16. The computing system of claim 15, wherein the instructions are further executable to determine a recommended diagnostic procedure.

17. The computing system of claim 16, wherein the instructions are further executable to output one or more of an alert indicating the anomalous condition or the recommended diagnostic procedure.

18. The computing system of claim 15, wherein the instructions are further executable to render an image of a virtual state of the processing tool using the runtime simulation.

19. The computing system of claim 18, wherein the image comprises one or more of a simulated thermal image, a simulated visible image, or a simulated density image, or a simulated field.

20. The computing system of claim 15, wherein the runtime simulation is a first runtime simulation, the runtime data is first runtime data, and the instructions are further executable to
obtain a first virtual state of the processing tool from the first runtime simulation of the digital twin simulated with the first runtime data from the process,
obtain a second virtual state of the processing tool from a second runtime simulation of the digital twin simulated with second runtime data from a process without anomalies,
compare at least a portion of the first virtual state to a corresponding portion of the second virtual state, and
output one or more differences in the comparison.
